(19) United States
(12) Patent Application Publication
(10) Pub. No.: US 2026/0177776 A1
(43) Pub. Date: Jun. 25, 2026

(54) OPTICAL IMAGING LENS

(71) Applicant: GENIUS ELECTRONIC OPTICAL (XIAMEN) CO., LTD., Xiamen (CN)

(72) Inventors: Fubao Wang, Xiamen (CN); Chuanze Ye, Xiamen (CN); Chen Chen, Xiamen (CN)

(73) Assignee: GENIUS ELECTRONIC OPTICAL (XIAMEN) CO., LTD., Xiamen (CN)

(21) Appl. No.: 19/408,381

(22) Filed: Dec. 4, 2025

(30) Foreign Application Priority Data
Dec. 24, 2024 (CN) 202411918315.4
Jan. 21, 2025 (CN) 202510091847.3
Aug. 5, 2025 (CN) 202511091877.0

(51) Int. Cl. G02B 7/02

(52) U.S. Cl. CPC G02B 7/028; G02B 7/021; G02B 7/025

(57) ABSTRACT

An optical imaging lens includes an outer cover, a lens barrel, a colloid, and a plurality of lens elements disposed in the lens barrel. In particular, the outer cover is cone-shaped and has a light transmittance of less than 10%, and is disposed at an outer surface of a front end portion of the lens barrel. The front end portion of the lens barrel has a lens barrel annular plane perpendicular to an optical axis and located on a reference plane. The colloid is disposed between the outer cover and the lens barrel. The colloid is a solid at less than 90° C. and is in a softened state when heated again to 50° C. to 75° C.

### CROSS-REFERENCE TO RELATED APPLICATION

This application claims the priority benefits of China application serial no. 202411918315.4, filed on Dec. 24, 2024, China application serial no. 202510091847.3, filed on Jan. 21, 2025, and China application serial no. 202511091877.0, filed on Aug. 5, 2025. The entirety of each of the above-mentioned patent applications is hereby incorporated by reference herein and made a part of this specification.

### BACKGROUND

### Technical Field

The disclosure relates to an optical element, and more particularly to an optical imaging lens.

### Description of Related Art

Specifications of portable electronic devices are constantly evolving, and key components thereof, optical imaging lenses, are also required to be continuously improved in specifications to meet consumer demands and be applied in various fields. Those skilled in the art know that using plastic materials to manufacture lens barrels, in addition to being easy to process, may also reduce the weight and cost, and therefore are widely applied in various optical lenses.

In the Chinese Utility Model Patent, CN209387961U, a lens module is provided. A metal insert is disposed in a plastic lens barrel. A supporting portion of the metal insert is disposed around an outer periphery of a top of the plastic lens barrel, which may protect the plastic lens barrel and improve structural strength of a top position of the lens barrel, so that the top of the lens barrel has good pressure resistance. However, from the cross-section, it has a structure with chamfers, where stress is more concentrated. Although it has pressure resistance at the top, it is easily damaged at a front end of a lens by impacts from other directions. In addition, no solution is provided for both reducing stray light and resisting drops.

In the Chinese Utility Model Patent, CN209525509U, in order to solve an issue that when a threadless lens barrel structure is matched with the lens, since strong glue is required to be used for high temperature curing, a thinner portion of a lens barrel wall thickness will be deformed, making it difficult for the lens to be matched with the lens barrel, a solution is provided. An implementation method thereof is to affix a metal sleeve to an outer surface of the lens barrel, so that after the lens barrel is cured at a high temperature, the thinner portion of the lens barrel wall thickness is protected by the metal sleeve, thereby enhancing overall strength of the lens barrel, making it less likely to deform, improving an ability of the lens barrel to resist deformation, and thus improving performance of the lens module. The lens barrel and the metal sleeve are integrally formed during an injection molding process, which may increase firmness of the lens module. However, in this case, it also has a structure with chamfers, where stress is more concentrated. In addition, it does not provide a method for improving structural strength of a top of an object-side end of the lens barrel while reducing the stray light, and it does not disclose how to maintain the structural strength of the lens while reducing a volume of the lens to prevent external impacts and drops from affecting performance of the lens.

In the Chinese utility model patent, CN208907936U, a lens module is provided. A lens barrel thereof includes a metal sleeve embedded in the lens barrel, and the lens barrel and the metal sleeve are formed integrally. The metal sleeve embedded in the lens barrel may greatly improve the ability of the lens barrel to resist deformation, so that when the lens barrel is assembled to the lens module, it will not be deformed due to the use of the strong glue for high temperature curing, thereby improving assembly stability and improving a product yield. However, the manufacturing difficulty and cost of this metal sleeve embedded in the lens barrel are high, and it also has a structure with chamfers, where stress is more concentrated. In addition, since an impact-receiving surface is still made of a plastic material, impact resistance is limited under the volume of the miniaturized lens.

With a trend of the portable electronic devices pursuing thin and short sizes, a volume of the lens module is getting smaller and smaller. Therefore, strength of the plastic material is no longer sufficient for the lens barrel to resist collisions and drops, resulting in the lens barrel being unable to protect internal components. Therefore, it is an objective that is required to be worked on today to provide a simple and economical way to improve the structural strength of the miniaturized lens module and prevent the external impacts and drops from affecting the performance of the lens while reducing the stray light.

### SUMMARY

The disclosure provides an optical imaging lens, that may facilitate the arrangement of an outer cover, a lens barrel, and a plurality of lens elements in sequence for easy assembly, enhance structural strength of a front end portion of the lens barrel, reduce a volume of the optical imaging lens, while improving drop resistance.

The disclosure provides an optical imaging lens including an outer cover, a lens barrel, and a plurality of lens elements disposed in the lens barrel along an optical axis from an object side to an image side. In particular, the outer cover is cone-shaped and has a light transmittance of less than 10%, and is disposed at an outer surface of a front end portion of the lens barrel. The front end portion of the lens barrel has an annular lens barrel plane perpendicular to the optical axis and located on a reference plane. In particular, the optical imaging lens satisfies following conditions: 9.900≤Dcvon/Wbr≤15.500 and 4≤CTEpc/CTEoc≤10, wherein Devon is a minimum outer diameter of the outer cover, Wbr is a width of the annular lens barrel plane on the reference plane, CTEpc is a coefficient of thermal expansion of the lens barrel, and CTEoc is a coefficient of thermal expansion of the outer cover. The optical imaging lens also includes a colloid disposed between the outer cover and the lens barrel, wherein the colloid is a solid at less than 90° C. and is in a softened state when heated again to 50° C. to 75° C.

In an embodiment of the disclosure, the colloid is a reactive polyurethane.

In an embodiment of the disclosure, the colloid is a UV delayed curing adhesive.

In an embodiment of the disclosure, one of the plurality of lens elements closest to the object side is a first lens element, and the outer cover is in contact with an object-side surface of the first lens element.

In an embodiment of the disclosure, an included angle between the outer cover annular plane and the outer cover conical surface is between 100 degrees and 110 degrees.

In an embodiment of the disclosure, a material of the outer cover is a metal.

In an embodiment of the disclosure, the outer cover may be a soft material, and a range of a Shore A hardness thereof is between 70 and 90.

In an embodiment of the disclosure, the outer cover is in contact with the lens barrel annular plane.

In an embodiment of the disclosure, the optical imaging lens satisfies a following condition: 1.120≤Dcv/Dbr≤1.201, wherein Dev is a maximum outer diameter of the outer cover on the reference plane, and Dbr is a maximum outer diameter of the lens barrel on the reference plane.

In an embodiment of the disclosure, the outer cover has an inner ring conical surface, and the optical imaging lens satisfies a following condition: 1.000≤Dinmax/Dinmin≤1.400, wherein Dinmax is a maximum inner diameter of the inner ring conical surface, and Dinmin is a minimum inner diameter of the inner ring conical surface.

In an embodiment of the disclosure, the optical imaging lens satisfies a following condition: 1.150≤Dcvox/Dcvon≤1.500, wherein Dcvox is a maximum outer diameter of the outer cover, and Devon is a minimum outer diameter of the outer cover.

Based on the above, in the optical imaging lens of the disclosure, the optical imaging lens includes an outer cover, a lens barrel, and a plurality of lens elements disposed in the lens barrel along an optical axis from an object side to an image side. In addition, the cone shape of the outer cover is not only easy to process, but also may disperse the impact force when the outer cover is disposed at the outer surface of the lens barrel. The chamfer-free structure design thereof may also reduce stress concentration, which may effectively avoid external impacts or drops, thereby reducing the possibility of local deformation and protecting safety of internal components. Furthermore, the optical imaging lens satisfies the following condition: 9.900≤Devon/Wbr≤15.500, wherein Dcvon is the minimum outer diameter of the outer cover and Wbr is the width of the lens barrel annular plane on the reference plane. Therefore, by controlling the minimum outer diameter of the outer cover and the width of the lens barrel annular plane on the reference plane, it is advantageous to control the wall thickness of the lens barrel to maintain the volume of the miniaturized lens. Furthermore, the optical imaging lens satisfies the following condition: 4≤CTEpc/CTEoc≤10, wherein CTEpc is the coefficient of thermal expansion of a lens barrel 120, and CTEoc is the coefficient of thermal expansion of an outer cover 110. Therefore, the optical imaging lens further includes the colloid disposed between the outer cover and the lens barrel. By using the colloid that is solid at less than 90° C. and in a softened state when heated again to 50° C. to 75° C., the issue of the lens barrel being unable to return to the original state due to heating and curing, causing stress pulling and ultimately deformation may be prevented.

In order for the aforementioned features and advantages of the disclosure to be more comprehensible, embodiments accompanied with drawings are described in detail below.

### BRIEF DESCRIPTION OF THE DRAWINGS

FIG. 1 is a schematic cross-sectional view of an optical imaging lens according to the first embodiment of the disclosure.

FIG. 2 is a schematic cross-sectional view of an optical imaging lens according to the second embodiment of the disclosure.

FIG. 3 is a schematic cross-sectional view of an optical imaging lens according to the third embodiment of the disclosure.

FIG. 4 is a schematic cross-sectional view of an optical imaging lens according to the fourth embodiment of the disclosure.

FIG. 5 is a schematic cross-sectional view of an optical imaging lens according to the fifth embodiment of the disclosure.

FIG. 6 is a schematic front view of an optical imaging lens according to the fifth embodiment of the disclosure.

FIG. 7 is a schematic front view of an optical imaging lens according to the sixth embodiment of the disclosure.

FIG. 8 is a schematic front view of an optical imaging lens according to the seventh embodiment of the disclosure.

FIG. 9 shows the values of various important parameters and the relational expressions thereof of the optical imaging lenses according to the first to fourth embodiments of the disclosure.

### DESCRIPTION OF THE EMBODIMENTS

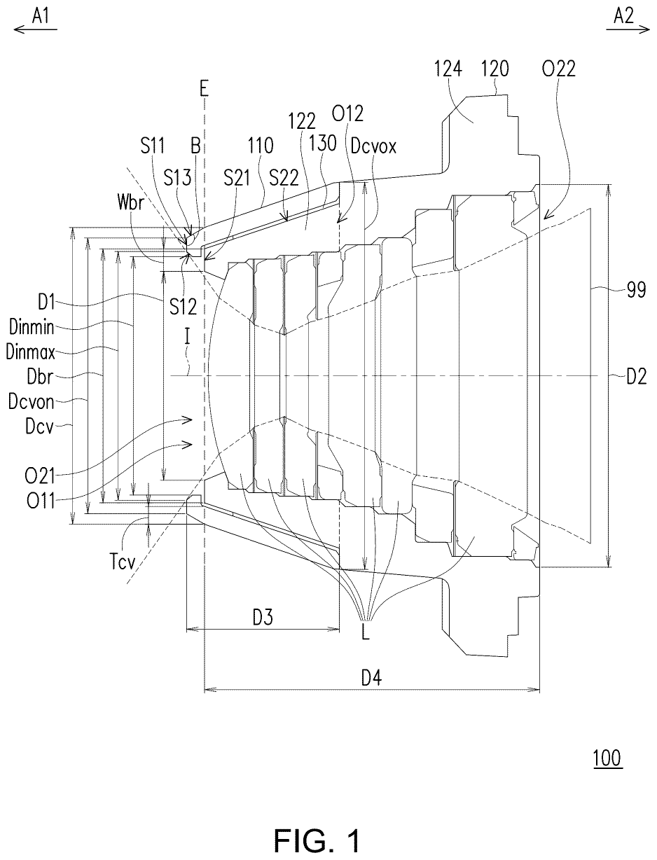

FIG. 1 is a schematic cross-sectional view of an optical imaging lens according to an embodiment of the disclosure. Please refer to FIG. 1. The present embodiment provides an optical imaging lens 100 including an outer cover 110, a lens barrel 120, and a plurality of lens elements L disposed in the lens barrel 120 along an optical axis I from an object side A1 to an image side A2. When light emitted by an object to be photographed enters the optical imaging lens 100 and passes through the lens elements L and filters, an image is formed at an image plane 99. In all embodiments of the disclosure, the number, shape, material, and type of the plurality of lens elements L are not limited.

The lens barrel 120 includes a front end portion 122 located close to the object side A1 and a rear end portion 124 located close to the image side A2. Specifically, the front end portion 122 and the rear end portion 124 are defined to distinguish relative positions, and the lens barrel 120 may be designed to be integrally formed without obvious boundaries. The front end portion 122 includes a lens barrel object-side opening O21, and the rear end portion 124 includes a lens barrel image-side opening O22. An inner diameter D1 of the lens barrel object-side opening O21 is less than an inner diameter D2 of the lens barrel image-side opening O22. Therefore, it is not only advantageous to arrange the outer cover 110, the lens barrel 120, and the plurality of lens elements L in sequence for easy assembly, but also advantageous to reduce the volume of the optical imaging lens system 100 while maintaining the wall thickness of the lens barrel 120. The front end portion 122 of the lens barrel 120 has a lens barrel annular plane S21 perpendicular to the optical axis I and located on a reference plane E, and an outer surface S22 facing away from the optical axis I.

The outer cover 110 is cone-shaped, specifically truncated cone-shaped, and is disposed at the outer surface S22 of the front end portion 122 of the lens barrel 120. The outer cover 110 includes an outer cover object-side opening O11 and an outer cover image-side opening O12. In particular, the maximum outer diameter of the outer cover object-side opening O11 (i.e., a minimum outer diameter Dcvon of the outer cover 110) is less than the maximum outer diameter of the outer cover image-side opening O12 (i.e., a maximum minimum outer diameter Dcvox of the outer cover 110). Therefore, the configuration of the outer cover 110 may help to improve strength of the front end portion 122 of the lens barrel 120. In addition, the cone shape of the outer cover 110 is not only easy to process, but also may disperse impact force when the outer cover 110 is disposed on the outer surface S22 of the lens barrel 120. The chamfer-free structure design thereof may also reduce stress concentration, which may effectively avoid external impacts or drops, thereby reducing the possibility of local deformation and protecting safety of internal components. The outer cover 110 has an outer cover annular plane S11 close to the object side A1 and perpendicular to the optical axis I, an inner ring conical surface S12 adjacent to the outer cover annular plane S11 and facing the optical axis I, and an outer cover conical surface S13 adjacent to the outer cover annular plane S11 and away from the optical axis I. In particular, the inner ring conical surface S12 of the outer cover 110 not only reduces generation of stray light, but also enhances strength of the outer cover object-side opening O11. A length D3 of the outer cover 110 on the optical axis I is greater than 40% of a length D4 of the lens barrel 120 on the optical axis I, which may increase a protection area of the lens barrel and also increase bonding force between the outer cover 110 and the lens barrel 120, thereby improving drop resistance.

In the present embodiment, the optical imaging lens 100 further includes a pressure sensitive adhesive (PSA) 130 disposed between the outer cover 110 and the lens barrel 120 to fix the outer cover 110 to the lens barrel 120. In this way, the bonding force may be increased, and the PSA 130 has buffering force, which may enable the optical imaging lens 100 to be more resistant to dropping.

In the present embodiment, an included angle B between the outer cover annular plane S11 and the outer cover conical surface S13 is between 100 and 110 degrees. In this way, it may disperse the impact force and reduce the stress concentration. In the present embodiment, the included angle B between the outer cover annular plane S11 and the outer cover conical surface S13 is, for example, 105 degrees.

In the present embodiment, the material of the outer cover 110 is metal, which may provide the optical imaging lens 100 with high strength and hardness characteristics and good drop resistance.

In the present embodiment, the outer cover 110 is in contact with the lens barrel annular plane S21 of the lens barrel 120. Therefore, the outer cover 110 may cover a front end of the lens barrel 120, thereby increasing impact resistance of the front end portion 122 of the lens barrel 120.

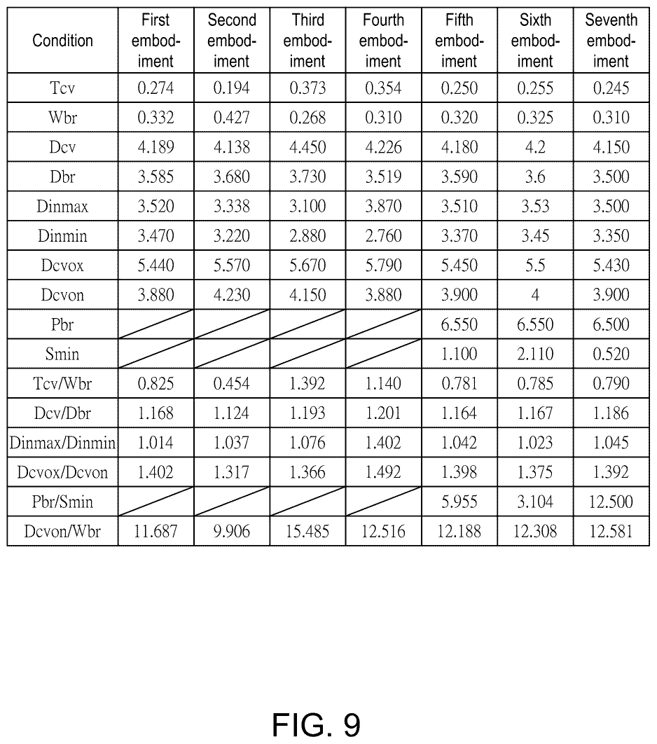

In addition, the relationship between the various important parameters in the optical imaging lens 100 of the first embodiment is shown in FIG. 9.

In particular,
Tcv is the thickness of the outer cover 110 on the reference plane E;
Wbr is the width of the barrel annular plane S21 on the reference plane E;
Dcv is the maximum outer diameter of the outer cover 110 on the reference plane E;
Dbr is the maximum outer diameter of the lens barrel 120 on the reference plane E;
Dinmax is the maximum inner diameter of the inner ring conical surface S12;
Dinmin is the minimum inner diameter of the inner ring conical surface S12;
Dcvox is the maximum outer diameter of the outer cover 110;
Dcvon is the minimum outer diameter of the outer cover 110.

In addition, the following are defined:
CTEpc is the coefficient of thermal expansion of the lens barrel 120;
CTEoc is the coefficient of thermal expansion of the outer cover 110.

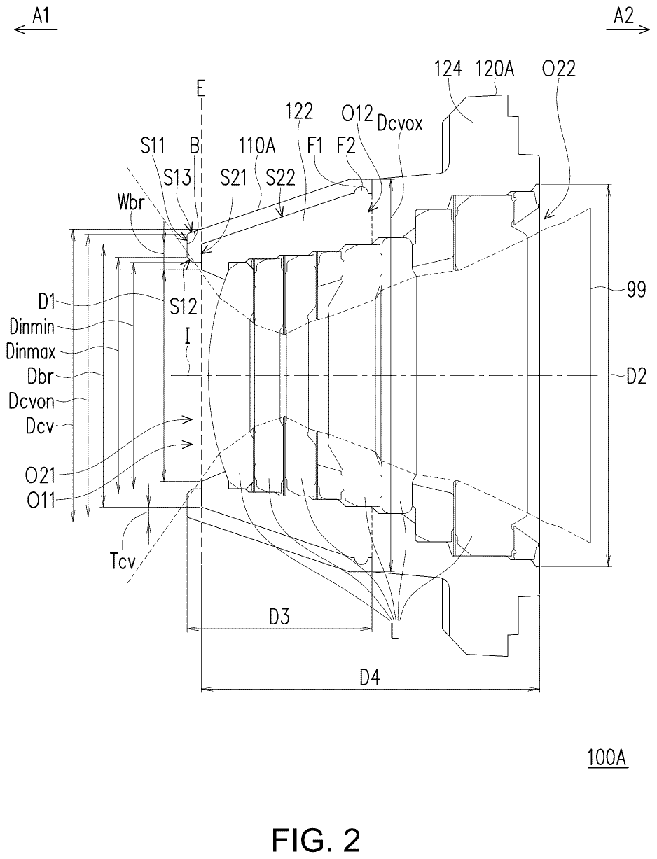

FIG. 2 is a schematic cross-sectional view of an optical imaging lens according to the second embodiment of the disclosure. Please refer to FIG. 2. An optical imaging lens 100A of the present embodiment is similar to the optical imaging lens 100 shown in FIG. 1. The difference between the two is that, in the present embodiment, the outer cover 110A and a lens barrel 120A are formed by insert injection. In the present embodiment, the outer cover 110A includes at least one outer cover embedding structure F1, the lens barrel 120A includes at least one lens barrel embedding structure F2, and the outer cover 110A is bonded to the at least one lens barrel embedding structure F2 of the lens barrel 120A via the at least one outer cover embedding structure F1. Therefore, compared to dispensing, in the present embodiment, one step may be reduced, so the process is simple, and bonding force of insert injection is stronger than that of glue. For example, in the present embodiment, the number of the at least one outer cover embedding structure F1 and the at least one lens barrel embedding structure F2 is the same, and the at least one lens barrel embedding structure F2 is a protruding structure and adjacent to the outer cover image-side opening O12. In this way, the bonding area may be further increased, and bonding force of the outer cover 110A may be strengthened. In the present embodiment, the included angle B between the outer cover annular plane S11 and the outer cover conical surface S13 is 100 degrees. In addition, the relationship between the various important parameters in the optical imaging lens 100A of the second embodiment is shown in FIG. 9.

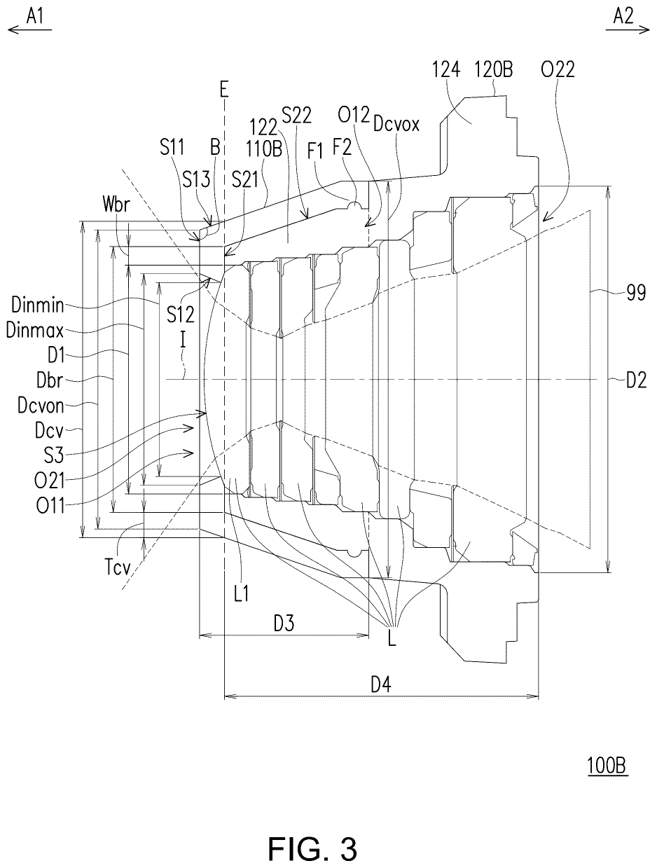

FIG. 3 is a schematic cross-sectional view of an optical imaging lens according to the third embodiment of the disclosure. Please refer to FIG. 3. An optical imaging lens 100B of the present embodiment is similar to the optical imaging lens 100 shown in FIG. 1. The difference between the two is that, in the present embodiment, an outer cover 110B and a lens barrel 120B are formed by insert injection. In the present embodiment, the outer cover 110B includes the at least one outer cover embedding structure F1, and the lens barrel 120B includes the at least one lens barrel embedding structure F2. The outer cover 110B is bonded to the at least one lens barrel embedding structure F2 of the lens barrel 120B via the at least one outer cover embedding structure F1. Therefore, compared to dispensing, in the present embodiment, one step may be reduced, so the process is simple, and the bonding force of insert injection is stronger than that of the glue. For example, in the present embodiment, the number of the at least one outer cover embedding structure F1 and the at least one lens barrel embedding structure F2 is the same, and the at least one lens barrel embedding structure F2 is a protruding structure and adjacent to the outer cover image-side opening O12. In this way, the bonding area may be further increased, and bonding force of the outer cover 110B may be strengthened. Furthermore, in the present embodiment, one of the plurality of lens elements L closest to the object side A1 is a first lens element L1, and the outer cover 110B is in contact with an object-side surface S3 of the first lens element L1. In this way, the length of the lens barrel 120B may be shortened, thereby reducing a total length of the optical imaging lens 100B and preventing the lens barrel 120B from being in direct contact with other materials and being corroded. In the present embodiment, the included angle B between the outer cover annular plane S11 and the outer cover conical surface S13 is 105 degrees. In addition, the relationship between the various important parameters in the optical imaging lens 100B of the third embodiment is shown in FIG. 9.

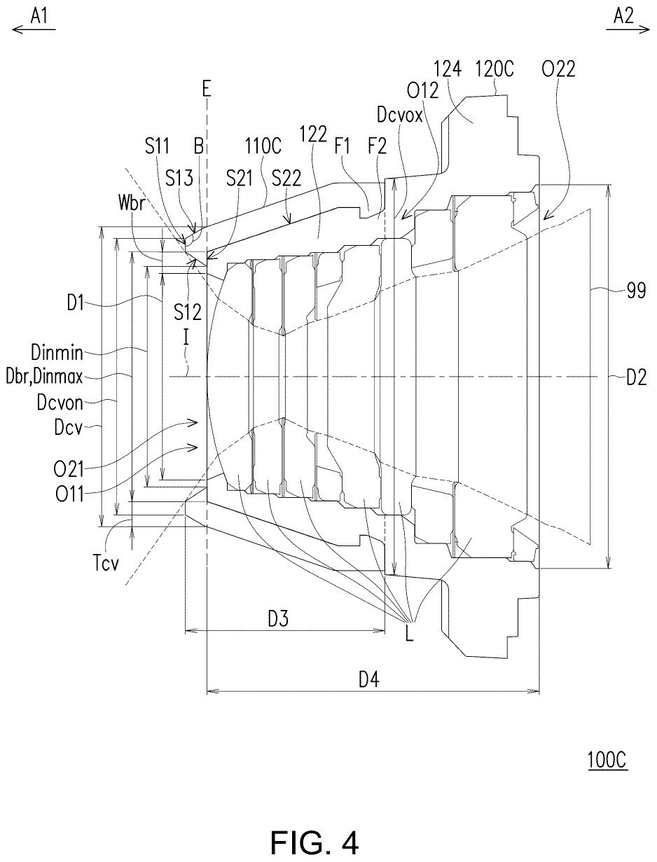

FIG. 4 is a schematic cross-sectional view of an optical imaging lens of the fourth embodiment of the disclosure. Please refer to FIG. 4. An optical imaging lens 100C of the present embodiment is similar to the optical imaging lens 100 shown in FIG. 1. The difference between the two is that, in the present embodiment, an outer cover 110C and a lens barrel 120C are formed by insert injection. In the present embodiment, the outer cover 110C includes the at least one outer cover embedding structure F1, the lens barrel 120C includes the at least one lens barrel embedding structure F2, and the outer cover 110C is bonded to the at least one lens barrel embedding structure F2 of the lens barrel 120C via the at least one outer cover embedding structure F1. Therefore, compared to dispensing, in the present embodiment, one step may be reduced, so the process is simple, and the bonding strength of insert injection is stronger than that of the glue. For example, in the present embodiment, the number of the at least one outer cover embedding structure F1 and the at least one lens barrel embedding structure F2 is the same, and the at least one lens barrel embedding structure F2 is a groove structure and located at the outer cover image-side opening O12. In this way, the bonding area may be further increased, and the bonding force of the outer cover 110C may be strengthened. Furthermore, in the present embodiment, the outer cover 110C may be a soft material, and the range of the Shore A hardness thereof is between 70 and 90. In the present embodiment, the included angle B between the outer cover annular plane S11 and the outer cover conical surface S13 is 110 degrees. In addition, the relationship between the various important parameters in the optical imaging lens 100C of the fourth embodiment is shown in FIG. 9.

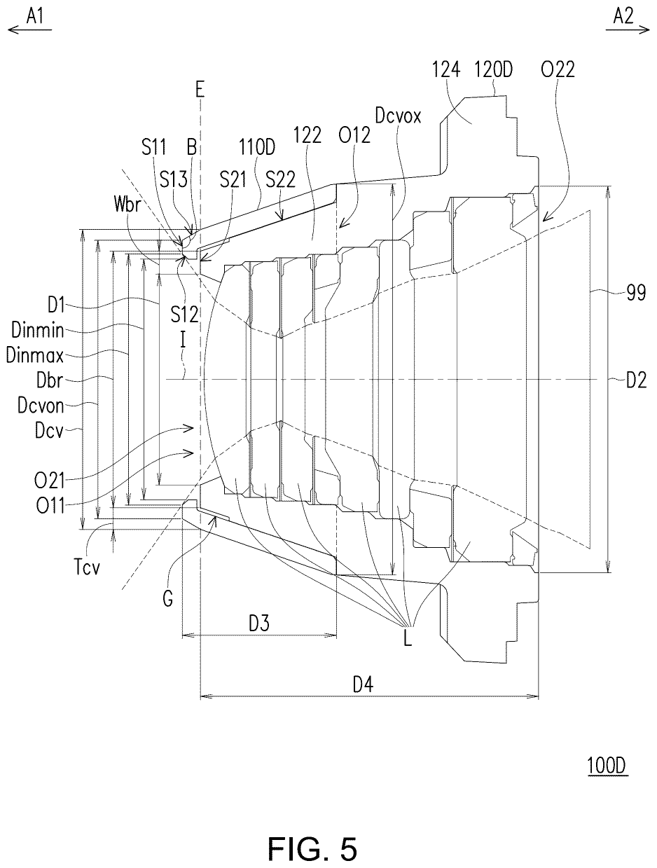

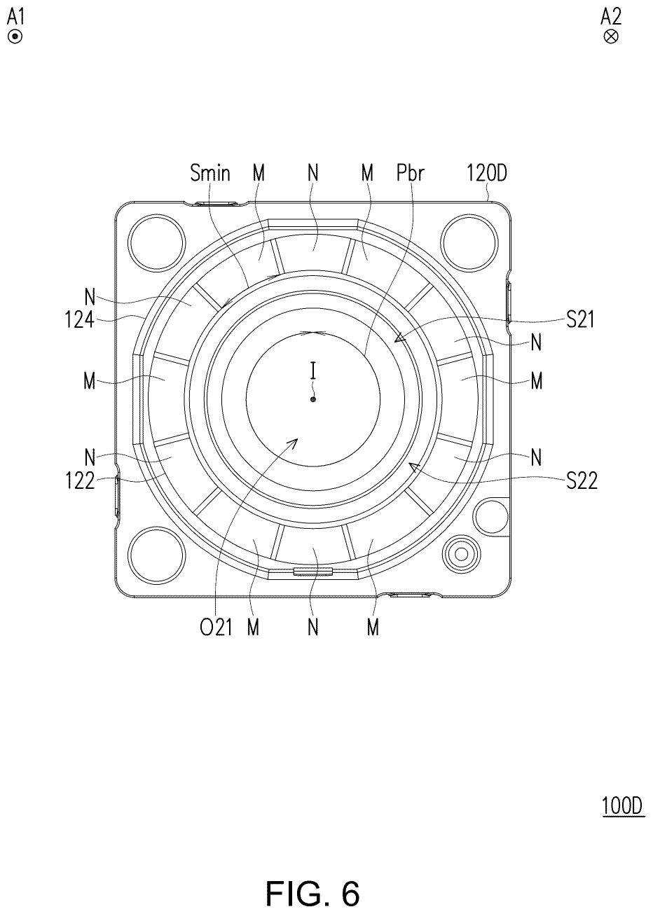

FIG. 5 is a schematic cross-sectional view of an optical imaging lens according to the fifth embodiment of the disclosure. FIG. 6 is a schematic front view of an optical imaging lens according to the fifth embodiment of the disclosure. Please refer to FIG. 5 and FIG. 6. An optical imaging lens 100D of the present embodiment is similar to the optical imaging lens 100 shown in FIG. 1. The difference between the two is that, in the present embodiment, an air gap G is disposed between the outer surface S22 of the front end portion 122 of a lens barrel 120D and an outer cover 110D. In this way, the air gap G may be used as a buffer structure to prevent the impact force from being directly transmitted to the front end portion 122 of the lens barrel 120D, thereby increasing the drop resistance. More specifically, the length of the air gap G on the optical axis I is 20% to 40% of the length of the outer cover 110D on the optical axis I. For example, in the present embodiment, the length of the air gap G on the optical axis I is 30% of the length of the outer cover 110D on the optical axis I. In this way, by further designing the ratio of the length of the air gap G to the length of the outer cover 110D, an appropriate buffer capacity may be obtained, while also achieving the effect of improving assembly yield.

Moreover, in the present embodiment, the outer surface S22 of the lens barrel 120D is provided with a plurality of dispensing areas M and a plurality of matching areas N arranged alternately. In particular, the number of the dispensing areas Mis the same as the number of the matching areas N. More specifically, the number of the dispensing areas Mis at least 3 and at most 12. For example, in the present embodiment, the outer surface S22 of the lens barrel 120D is provided with 6 dispensing areas M and 6 matching areas N arranged alternately. In this way, it is possible to avoid a combination of the outer cover 110D and the lens barrel 120D being unstable and failing to achieve the function of improving dimensional accuracy due to too few dispensing areas M, and to avoid the width being narrowed due to too many dispensing areas M, thereby reducing production efficiency. Each of the dispensing areas M has a receiving groove for receiving the glue, and the depth of the receiving groove is between 0.005 mm and 0.100 mm. The matching areas N are in direct contact with the outer cover 110D. In addition, the relationship between the various important parameters in the optical imaging lens 100D of the fifth embodiment is shown in FIG. 9.

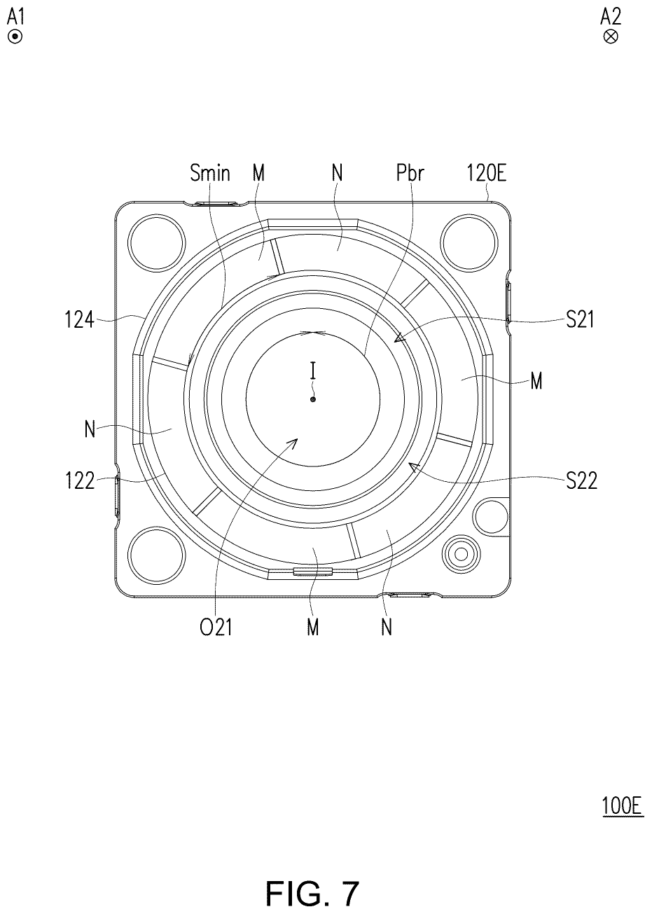

FIG. 7 is a schematic front view of an optical imaging lens according to the sixth embodiment of the disclosure. Referring to FIG. 7, for convenience of description, FIG. 7 shows the outer cover in a hidden manner. An optical imaging lens 100E of the present embodiment is similar to the optical imaging lens 100D shown in FIG. 6. The difference between the two is that in the present embodiment, the outer surface S22 of a lens barrel 120E is provided with 3 dispensing areas M and 3 matching areas N arranged alternately. In this way, it is possible to avoid a combination of the outer cover and the lens barrel 120E being unstable and failing to achieve the function of improving dimensional accuracy due to too few dispensing areas M, and to avoid the width being narrowed due to too many dispensing areas M, thereby reducing the production efficiency. In addition, the relationship between the various important parameters in the optical imaging lens 100E of the sixth embodiment is shown in FIG. 9.

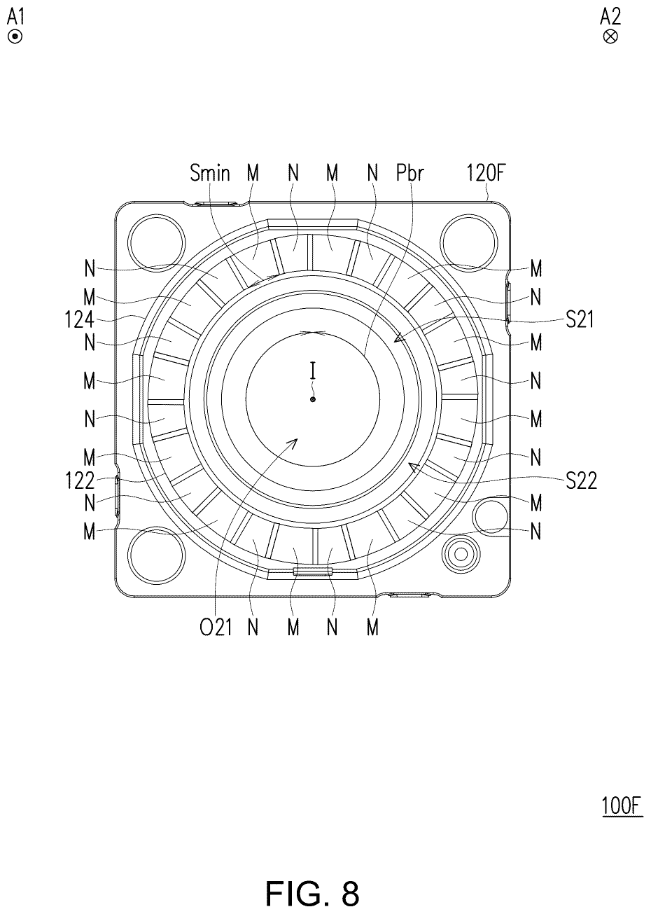

FIG. 8 is a schematic front view of an optical imaging lens according to the seventh embodiment of the disclosure. Referring to FIG. 8, for convenience of description, FIG. 8 shows the outer cover in a hidden manner. An optical imaging lens 100F of the present embodiment is similar to the optical imaging lens 100D shown in FIG. 6. The difference between the two is that in the present embodiment, the outer surface S22 of a lens barrel 120F is provided with 12 dispensing areas M and 12 matching areas N arranged alternately. In this way, it is possible to avoid a combination of the outer cover and the lens barrel 120F being unstable and failing to achieve the function of improving dimensional accuracy due to too few dispensing areas M, and to avoid the width being narrowed due to too many dispensing areas M, thereby reducing the production efficiency. In addition, the relationship between the various important parameters in the optical imaging lens 100F of the sixth embodiment is shown in FIG. 9.

Please refer to FIG. 1. The schematic cross-sectional view of the optical imaging lens according to the eighth embodiment of the disclosure is similar to the schematic cross-sectional view shown in FIG. 1. For ease of description, FIG. 1 is used as an example. The only difference between the two is that in the present embodiment, a colloid is disposed in the optical imaging lens to replace the PSA 130 shown in FIG. 1. The outer cover 110 is cone shaped and disposed at the outer surface S22, which is not only easy to process, but also may disperse the impact force, reduce the chamfered structure of stress concentration, effectively avoid external impacts or drops, reduce the possibility of local deformation, and protect the safety of internal components. Furthermore, the optical imaging lens 100 of the present embodiment further satisfies of 9.900≤Dcvon/Wbr≤15.500. By controlling the minimum outer diameter Dcvon of the outer cover 110 and the width Wbr of the lens barrel annular plane S21 on the reference plane E, it is advantageous to control the wall thickness of the lens barrel 120 to maintain the volume of the miniaturized lens.

Regarding the placement and selection of the colloid of the present embodiment, thermosetting adhesive is most commonly used in the industry for lens assembly. This is because thermosetting adhesive undergoes an irreversible chemical cross-linking reaction upon heating, transforming from a liquid to a solid. Therefore, after curing, the thermosetting adhesive may not soften or melt again, achieving advantages such as high heat resistance and chemical resistance. This high heat resistance and chemical resistance facilitate passing high-temperature and low-temperature cycling reliability testing. However, when the coefficient of thermal expansion of the lens barrel 120 is between 4 times and 10 times the coefficient of thermal expansion of the outer cover 110 (4≤CTEpc/CTEoc≤10), if the outer cover 110 is disposed on the outer surface S22 of the front end portion 122 of the lens barrel 120 via thermosetting adhesive and subjected to a heat curing process for a period of time (e.g., maintaining a temperature of 95° C. for one hour), the thermal expansion of the lens barrel 120 exceeding 4 times or more that of the outer cover 110 causes the space for the thermosetting adhesive to be squeezed and reduced during the curing process. Therefore, as the outer cover 110 and the lens barrel 120 return to room temperature, the lens barrel 120 is unable to return to the original state due to the adhesion of the lens barrel 120 to the outer cover 110 during the heating and expansion process, resulting in stress pulling and eventually causing deformation of the lens barrel 120. Therefore, the deformation of the lens barrel 120 shifts the lens position, leading to various imaging quality issues such as lens decentration. Furthermore, since the light transmittance of the outer cover 110 is less than 10% (for example, metal in the present embodiment), conventional UV adhesive may not be used for bonding. To address the above requirements for drop resistance, thickness, and material limitations, using a colloid that is solid at less than 90° C. and in a softened state when heated again to 50° C. to 75° C. may avoid the above issue of the lens barrel 120 deforming caused by heat curing. Specifically, the colloid may be reactive polyurethane (RPU), which is solid at less than 90° C. and becomes liquid when preheated to 90° C. to 120° C. The colloid is injected between the lens barrel 120 and the outer cover 110 via a syringe and cured at room temperature (1 day to 7 days), avoiding the deformation issue of the lens barrel 120 caused by heat curing. The colloid is in a softened state when heated again to 50° C. to 75° C. In particular, the preferred melting working temperature of the reactive polyurethane is 110° C. to 120° C., which is advantageous to reducing the heating time to 30 minutes, shortening the process. Moisture-curing adhesive is solid at less than 90° C. and is in a softened state when heated again to 50° C. to 75° C. In another embodiment, the colloid may be a UV delayed curing adhesive, which is a liquid at room temperature. The colloid may be injected directly onto the lens barrel 120 via a syringe and exposed to UV light. The outer cover 110 may then be assembled and cured at room temperature (1 day to 7 days). This not only avoids the issue of the outer cover 110 being opaque and unable to be used with conventional UV adhesive, but may also prevent the deformation issue of the lens barrel 120 caused by heat curing. UV delayed curing adhesive is solid at less than 90° C. and is in a softened state when heated again to 50° C. to 75° C. In particular, compared to the PSA 130, reactive polyurethane has a higher yield in automated production since the PSA 130 is produced in sheets and adhered to the conical surface S12, which is more prone to unevenness. Therefore, injecting reactive polyurethane as a liquid onto the conical surface S12 of the lens barrel 120 has a higher yield. Furthermore, regarding the choice of the colloid, while moisture-curing adhesive also avoids the heat-curing process, since the colloid is disposed between the outer cover 110 and the outer surface S22 of the front end portion 122 of the lens barrel 120, the surface area exposed to moisture in the air is extremely small. Compared to reactive polyurethane and UV delayed curing adhesive, which undergo chemical reactions such as heating or UV light exposure before bonding, moisture-curing adhesive requires a longer room-temperature cure time, increasing the lens production cycle. Furthermore, the extremely small area exposed to moisture in the air may be the reason why it is difficult to pass the reliability test of the −30° C. to 75° C. cycle. Based on the above, reactive polyurethane or UV delayed curing adhesive is bonded and cured at the outer cover 110 and the outer surface S22 of the front end portion 122 of the lens barrel 120 in an environment satisfying the conditions such as 9.900≤Dcvon/Wbr≤15.500 and 4≤CTEpc/CTEoc≤10. This not only may avoid the deformation issue caused by heat curing, but also improves the yield of automated production, shortens the time and cycle of lens production, and is more advantageous to the lens passing the reliability test of the −30° C. to 75° C. cycle, thereby improving production quality and yield. The following lists the coefficients of thermal expansion of the lens barrel 120 or the outer cover 110 of different materials.

| Material | Coefficient of thermal expansion (ppm/° C.) |
|---|---|
| PC (lens barrel) | 7 |
| Stainless steel (outer cover) | 1.7 |
| Copper (outer cover) | 1.65 |
| Glass (outer cover) | 0.72 |

Furthermore, in each of the above embodiments, when the optical imaging lenses 100, 100A to 100F satisfy the following condition: 0.450≤Tcv/Wbr≤1.400, controlling the ratio of the width Wbr of the lens barrel annular plane S21 to the thickness Tcv of the outer covers 110, 110A to 110D may be advantageous to maintain the volume of the miniaturized lens and at the same time ensure the strength of the drop resistance of the optical imaging lenses 100, 100A to 100F.

Furthermore, in each of the above embodiments, when the optical imaging lenses 100, 100A to 100F satisfy the following condition: 1.120≤Dcv/Dbr≤1.201, controlling the ratio of the maximum outer diameter Dbr of the lens barrels 120, 120A to 120F to the maximum outer diameter Dcv of the outer covers 110, 110A to 110D on the same plane may be advantageous to maintain the volume of the miniaturized lens and at the same time ensure the strength of the drop resistance of the optical imaging lenses 100, 100A to 100F.

In addition, in each of the above embodiments, when the optical imaging lenses 100, 100A to 100F satisfy the following condition: 1.000≤Dinmax/Dinmin≤1.400, by controlling the ratio of the maximum inner diameter Dinmax and the minimum inner diameter Dinmin of the inner ring conical surface S12 of the outer cover object-side opening O11, the slope of the conical surface S12 can be controlled to achieve the effect of reducing stray light.

Furthermore, in each of the above embodiments, when the optical imaging lenses 100, 100A to 100F satisfy the following condition: 1.150≤Dcvox/Dcvon≤1.500, the slope of the cone shape of the outer covers 110, 110A to 110D may be controlled by adjusting the ratio of the maximum outer diameter Devox to the minimum outer diameter Dcvon of the outer covers 110, 110A to 110D, to achieve the effects of dispersing impact forces and reducing stress concentration.

Furthermore, in the fifth to seventh embodiments, the optical imaging lenses 100D, 100E, and 100F also satisfy the following condition: 3.100≤Pbr/Smin≤12.50, wherein Pbr is the minimum circumference of the lens barrel object-side opening O21, and Smin is the minimum arc length of one of the plurality of dispensing areas M close to the object side A1. In this way, a dispensing area may be adjusted by controlling the arc length of the dispensing areas M, and appropriate sizes of the lens barrels 120D, 120E, and 120F may be matched to improve the deformation of the lens barrels 120D, 120E, and 120F and improve manufacturing yield.

Based on the above, in the optical imaging lens of the disclosure, the optical imaging lens includes the outer cover, the lens barrel, and the plurality of lens elements disposed in the lens barrel along the optical axis from the object side to the image side. In particular, the front end portion of the lens barrel includes the lens barrel object-side opening, and the back end portion of the lens barrel includes the lens barrel image-side opening, and the inner diameter of the lens barrel object-side opening is less than the inner diameter of the lens barrel image-side opening. Therefore, it is not only advantageous to arrange the outer cover, the lens barrel, and the plurality of lens elements in sequence for easy assembly, but also advantageous to reduce the volume of the optical imaging lens while maintaining the wall thickness of the lens barrel. In addition, the outer cover includes the outer cover object-side opening and the outer cover image-side opening, and the maximum outer diameter of the outer cover object-side opening is less than the maximum outer diameter of the outer cover image-side opening. Therefore, the provision of the outer cover may help to improve the strength of the front end portion of the lens barrel. In addition, the length of the outer cover on the optical axis is greater than 40% of the length of the lens barrel on the optical axis. Therefore, the protection area of the lens barrel may be increased, and the bonding force between the outer cover and the lens barrel may also be increased, thereby improving drop resistance. In addition, the cone shape of the outer cover is not only easy to process, but also may disperse the impact force when the outer cover is disposed at the outer surface of the lens barrel. The chamfer-free structure design thereof may also reduce stress concentration, which may effectively avoid external impacts or drops, thereby reducing the possibility of local deformation and protecting the safety of the internal components. In addition, the optical imaging lens satisfies the following condition: 0.450≤Tcv/Wbr≤1.400, wherein Tcv is the thickness of the outer cover on the reference plane, and Wbr is the width of the lens barrel annular plane on the reference plane. Therefore, by controlling the ratio of the width of the lens barrel annular plane to the thickness of the outer cover, the volume of the miniaturized lens may be maintained while ensuring the strength of the drop resistance of the optical imaging lens.

Moreover, in the optical imaging lens of the disclosure, the optical imaging lens includes the outer cover, the lens barrel, and the plurality of lens elements disposed in the lens barrel along the optical axis from the object side to the image side. In addition, the cone shape of the outer cover is not only easy to process, but also may disperse the impact force when the outer cover is disposed at the outer surface of the lens barrel. The chamfer-free structure design thereof may also reduce stress concentration, which may effectively avoid external impacts or drops, thereby reducing the possibility of local deformation and protecting safety of internal components. Furthermore, the optical imaging lens satisfies the following condition: 9.900≤Dcvon/Wbr≤15.500, wherein Dcvon is the minimum outer diameter of the outer cover and Wbr is the width of the lens barrel annular plane on the reference plane. Therefore, by controlling the minimum outer diameter of the outer cover and the width of the lens barrel annular plane on the reference plane, it is advantageous to control the wall thickness of the lens barrel to maintain the volume of the miniaturized lens. Furthermore, the optical imaging lens satisfies the following condition: 4≤CTEpc/CTEoc≤10, wherein CTEpc is the coefficient of thermal expansion of the lens barrel 120, and CTEoc is the coefficient of thermal expansion of the outer cover 110. Therefore, the optical imaging lens further includes the colloid disposed between the outer cover and the lens barrel. By using the colloid that is solid at less than 90° C. and in a softened state when heated again to 50° C. to 75° C., the issue of the lens barrel being unable to return to the original state due to heating and curing, causing stress pulling and ultimately deformation may be prevented.

Although the disclosure has been disclosed above with reference to the embodiments, they are not intended to limit the disclosure. Anyone with ordinary skill in the art may make slight changes and modifications without departing from the spirit and scope of the disclosure. Therefore, the scope of protection of the disclosure shall be determined by the scope of the appended patent applications.

What is claimed is:

1. An optical imaging lens, comprising an outer cover, a lens barrel, and a plurality of lens elements disposed in the lens barrel along an optical axis from an object side to an image side, wherein,
the outer cover is cone-shaped and has a light transmittance of less than 10%, and is disposed at an outer surface of a front end portion of the lens barrel;
the front end portion of the lens barrel has a lens barrel annular plane perpendicular to the optical axis and located on a reference plane;
wherein the optical imaging lens satisfies following conditions: 9.900≤Dcvon/Wbr≤15.500 and 4≤CTEpc/CTEoc≤10, wherein Dcvon is a minimum outer diameter of the outer cover, Wbr is a width of the lens barrel annular plane on the reference plane, CTEpc is a coefficient of thermal expansion of the lens barrel, and CTEoc is a coefficient of thermal expansion of the outer cover; and the optical imaging lens further comprises a colloid disposed between the outer cover and the lens barrel, wherein the colloid is a solid at less than 90° C. and is in a softened state when heated again to 50° C. to 75° C.

2. The optical imaging lens according to claim 1, wherein the colloid is a reactive polyurethane.

3. The optical imaging lens according to claim 1, wherein the colloid is a UV delayed curing adhesive.

4. The optical imaging lens according to claim 1, wherein one of the plurality of lens elements closest to the object side is a first lens element, and the outer cover is in contact with an object-side surface of the first lens element.

5. The optical imaging lens according to claim 1, wherein an included angle between the outer cover annular plane and the outer cover conical surface is between 100 degrees and 110 degrees.

6. The optical imaging lens according to claim 1, wherein a material of the outer cover is a metal.

7. The optical imaging lens according to claim 1, wherein a material of the outer cover is a soft material, and a range of a Shore A hardness thereof is between 70 and 90.

8. The optical imaging lens system according to claim 1, wherein the outer cover is in contact with the lens barrel annular plane.

9. The optical imaging lens according to claim 1, wherein the optical imaging lens satisfies a following condition: 1.120≤Dcv/Dbr≤1.201, wherein Dcv is a maximum outer diameter of the outer cover on the reference plane, and Dbr is a maximum outer diameter of the lens barrel on the reference plane.

10. The optical imaging lens according to claim 1, wherein the outer cover has an inner ring conical surface, wherein the optical imaging lens satisfies a following condition: 1.000≤Dinmax/Dinmin≤1.400, wherein Dinmax is a maximum inner diameter of the inner ring conical surface, and Dinmin is a minimum inner diameter of the inner ring conical surface.

11. The optical imaging lens according to claim 1, wherein the optical imaging lens satisfies a following condition: 1.150≤Dcvox/Dcvon≤1.500, wherein Dcvox is a maximum outer diameter of the outer cover.

12. The optical imaging lens system according to claim 1, wherein there is an air gap between the outer surface of the front end portion of the lens barrel and the outer cover.

13. The optical imaging lens according to claim 12, wherein a length of the air gap on the optical axis is 20% to 40% of a length of the outer cover on the optical axis.

14. The optical imaging lens according to claim 1, wherein the outer surface of the lens barrel is provided with a plurality of dispensing areas and a plurality of matching areas arranged alternately, a number of the dispensing areas is the same as a number of the matching areas, each of the dispensing areas has a receiving groove for receiving glue, wherein a depth of the receiving groove is between 0.005 mm and 0.100 mm, and the matching areas are in direct contact with the outer cover.

15. The optical imaging lens according to claim 14, wherein the number of the dispensing areas is at least 3 and at most 12.

16. The optical imaging lens according to claim 14, wherein the optical imaging lens satisfies a following condition: 3.100≤Pbr/Smin≤12.50, wherein Pbr is a minimum circumference of the lens barrel object-side opening, and Smin is a minimum arc length of one of the dispensing areas close to the object side.
